(19) United States
(12) Patent Application Publication
(10) Pub. No.: US 2003/0189112 A1
(43) Pub. Date: Oct. 9, 2003

(54) FUEL INJECTION VALVE

(76) Inventors: NORIHISA FUKUTOMI, TOKYO (JP); MASAYUKI AOTA, TOKYO (JP); OSAMU MATSUMOTO, TOKYO (JP)

Correspondence Address: SUGHRUE MION ZINN MACPEAK & SEAS, 2100 PENNSYLVANIA AVENUE NW, WASHINGTON, DC, 20037

(21) Appl. No.: 09/413,348

(22) Filed: Oct. 6, 1999

(30) Foreign Application Priority Data
Apr. 6, 1999 (JP) 11-099462

(51) Int. Cl. F02M 51/00; F16K 31/12; B05B 1/30

(52) U.S. Cl. 239/585.1; 239/585.5; 251/50; 251/48; 138/26; 138/30

(57) ABSTRACT

To generate the effective damping relative to the change of fuel pressure when a needle valve is closed and to decrease the generation of after-dripping right after injection (spray), a rubber ring is provided between a core and a sleeve adapted to seal the fuel.

### BACKGROUND OF THE INVENTION

1. Field of the Invention

The present invention relates to a fuel injection valve for an internal combustion engine and more particularly to the construction of the fuel injection valve for decreasing after-dripping of injection.

2. Description of the Prior Art

FIG. 8 is a sectional view showing the construction of a conventional fuel injection valve 50 disclosed, for example, in Japanese Laid-Open Patent Application (Kokai) No. Hei 8-7469 where a sleeve 17 is provided between a core 4 and a valve holder 11 and a fastening portion of the sleeve 17 is designed to seal the fuel. This fuel injection valve 50 electrifies a coil 6 of a solenoid 2 and as a result, an armature 8 is attracted by the magnetic force toward the core 4 to raise a needle valve 15 integrally connected to said armature 8, wherein the high-pressure fuel within the valve body 11 is injected from an end port (a nozzle opening) 13B of an orifice 12 formed in a valve seat 13 to the inside of a fuel chamber of an internal combustion engine (not shown).

However, since such a conventional fuel injection valve 50 is not provided with any elastic body such as rubber and plastics adapted to generate damping relative to the change of fuel pressure when the needle valve is closed, at a portion of the upstream side from an air gap between an armature 8 and a flat portion 15d of the needle valve 15 and of the downstream side from a rod (a spring stopper) 16p contacting the fuel, no remarkable pressure difference was found between the upstream and downstream sides of the needle valve 15. Accordingly, load for controlling the bouncing after valve-closing collision when the needle valve is closed does not affect the needle valve 15. Therefore, after-dripping of injection due to said bouncing generates and exerts a bad influence on the combustion quality of an engine.

Namely, as shown in FIG. 9(a), when the electrification to the coil 6 is shut off in a time t=t 0, as shown in FIG. 9(b), the needle valve 15 gradually starts to close the valve from a time t1 later than said time t0. However, as the needle valve 15 bounds after that, after-dripping of injection generates in a time t=t3. FIGS. 10(a) to (c) schematically show an outline of the fuel spray shape from the fuel injection valve 50 in said each time t=t1, t2, or t3. As this after-dripping of injection is not fully granulated, it exerts a bad influence on the combustion quality of the engine (e.g. the deterioration of the exhaust gas).

FIG. 11 is a view showing the variation with time of the pressure (pressure waveform) in the vicinity of the needle valve 15 in said operation. When the needle valve 15 starts to close the valve from a time t=t1, said pressure starts to gradually go up from the set fuel pressure (e.g. 5 Mpa). When the needle valve 15 starts to bound after a time t=t2, the pressure drops one time. If there is no elastic body in the vicinity of the needle valve 15, both the upstream and downstream sides of the needle valve 15 show the same pressure waveform. However, if there is provided any elastic body on the upstream side of the needle valve 15 and it damps the change of fuel pressure, as shown in FIG. 12(a), the pressure waveform on the upstream side of the needle valve 15 is shown for the pressure drop to be damped at a time t=t3. Therefore, as obvious from a comparison between the pressure waveform on the upstream side as shown in FIG. 12(a) and the pressure waveform on the downstream side as shown in FIG. 12(b), the pressure on the upstream side of the needle valve 15 is higher than that on the downstream thereof at a time t=t3 and a force in a valve-closing direction due to said pressure difference is applied on the needle valve 15. Thus, it is possible to reduce the bound of the needle valve 15.

Also, as shown in FIG. 13, there is proposed another mechanism of fuel injection valve 51 in which an O-ring 24A is inserted, to seal the fuel, between a core 4 and a housing 21 on a nozzle opening side from a coil bobbin 7 [Japanese Laid-Open utility Model Application (Kokai) No. Hei 6-4366]. However, said O-ring 24A is made of an elastic body, but its diameter is so small that there is hardly any portion to contact the fuel. It is therefore impossible for the O-ring to generate effective damping relative to the change of fuel pressure when the needle valve 15 is closed and no remarkable pressure difference was found between the upstream and downstream sides of the needle valve 15. Accordingly, in said fuel injection valve 51, as the load for controlling the bouncing after the valve-closing collision when the needle valve is closed does not affect the needle valve 15, after-dripping of injection due to bouncing generates and exerts a bad influence on the combustion quality of an engine.

### SUMMARY OF THE INVENTION

It is therefore an object of the present invention to provide a fuel injection valve which overcomes all of the above-noted drawbacks in the prior art and can generate effective damping relative to the change of fuel pressure when a needle valve is closed, thereby decreasing the generation of after-dripping of injection right after that.

According to claim 1 of the present invention, there is provided a fuel injection valve in which a buffer portion for damping the change of fuel pressure when a needle valve is closed, is provided at a portion of an armature contacting the fuel on the upstream side from an end of a nozzle opening side.

According to claim 2 of the present invention, there is provided a fuel injection valve in which said buffer portion is formed by inserting an elastic member between a sleeve disposed between a core and a valve holder of a solenoid, and said core.

According to claim 3 of the present invention, there is provided a fuel injection valve in which said buffer portion is formed by inserting an elastic member between a sleeve disposed between a core and a valve body of a solenoid and extending to the outer periphery of said valve body,and said core.

According to claim 4 of the present invention, there is provided a fuel injection valve comprising a coil case provided between a core and a valve body and adapted to seal, at its inner and outer diameter sides thereof, the core and the valve body by O-rings; a sleeve provided on the inner diameter side of the coil case and forming an air gap between the same and the valve body, wherein said buffer portion is formed by each of said O-rings.

According to claim 5 of the present invention, there is provided a fuel injection valve, in which the buffer portion is formed by enlarging the diameter of the O-ring which is inserted between the core and a housing on a nozzle opening side of a coil bobbin.

The above and other objects, features and advantages of the present invention will become more apparent from the following description when taken in conjunction with the accompanying drawings.

### BRIEF DESCRIPTION OF THE ACCOMPANYING DRAWINGS

FIG. 1 is a view showing the construction of a fuel injection valve according to the first embodiment of the present invention;

FIG. 2 is a view showing the construction of a fuel injection valve according to the second embodiment of the present invention;

FIG. 3 is a view showing the construction of a fuel injection valve according to the third embodiment of the present invention;

FIG. 4 is a view showing the construction of a fuel injection valve according to the fourth embodiment of the present invention;

FIG. 5 is a view showing the construction of a fuel injection valve according to the fifth embodiment of the present invention;

FIG. 6 is a view showing the construction of a fuel injection valve according to the sixth embodiment of the present invention;

FIGS. 7(a) and (b) are a view comparing the spray condition of the fuel injection valves;

FIG. 8 is a view showing the construction of a conventional fuel injection valve;

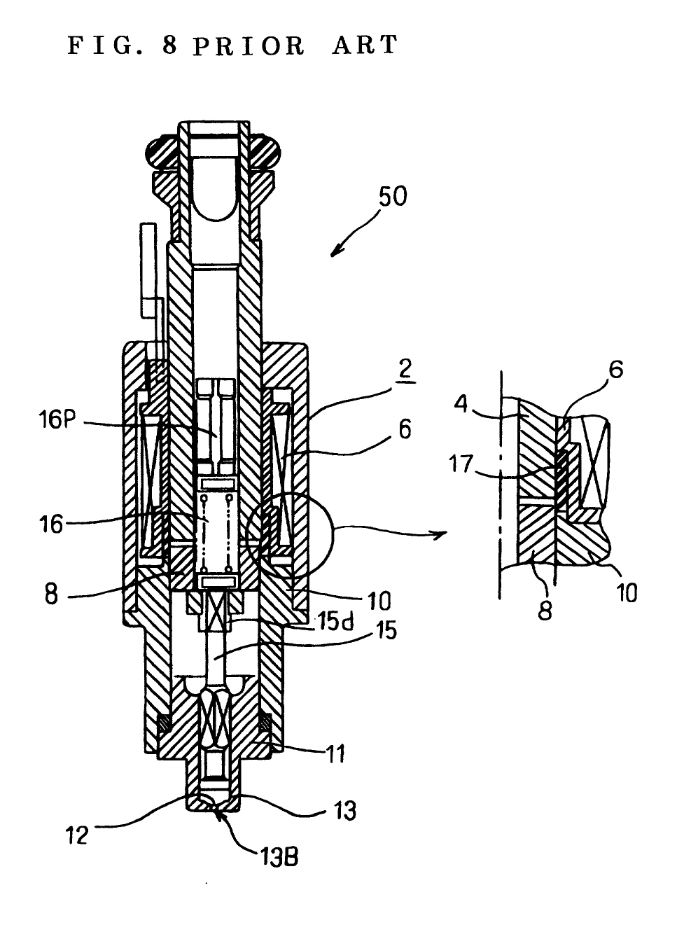

FIGS. 9(a) and (b) are a view explaining the bouncing of the conventional fuel injection valve;

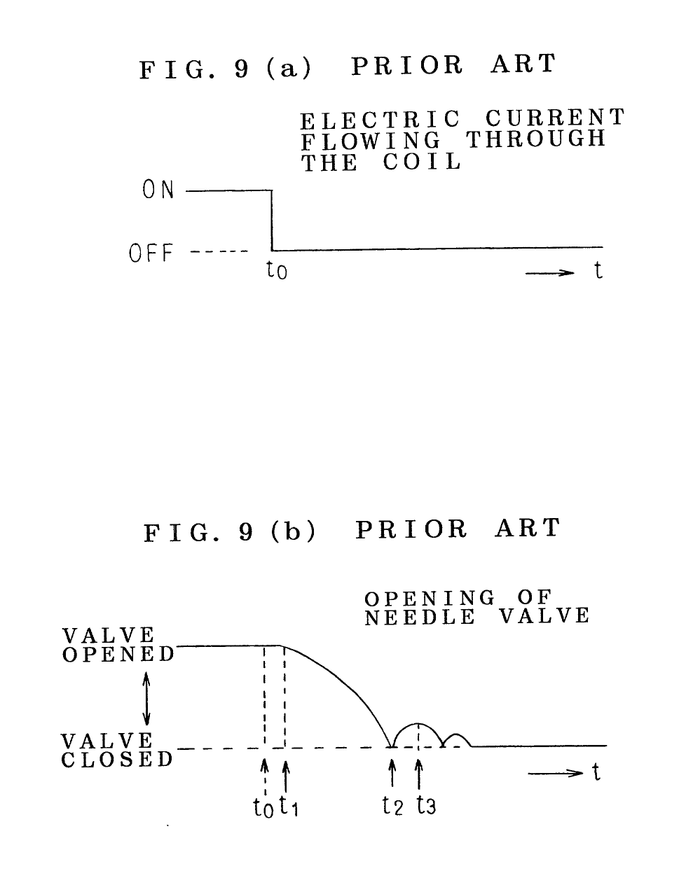

FIGS. 10(a), (b) and (c) are view showing an outline of the spray condition in the conventional fuel injection valve;

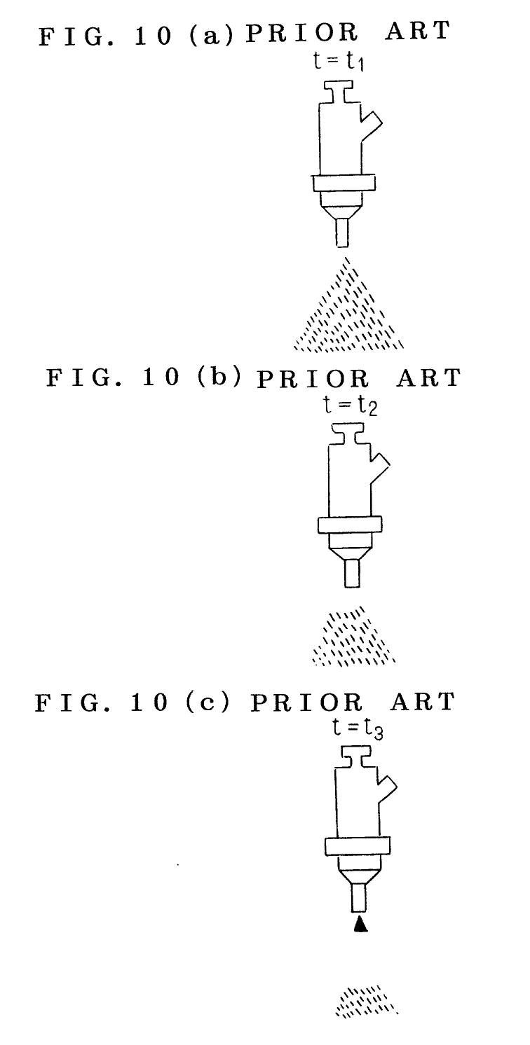

FIG. 11 is a view showing a pressure waveform in the vicinity of a needle valve;

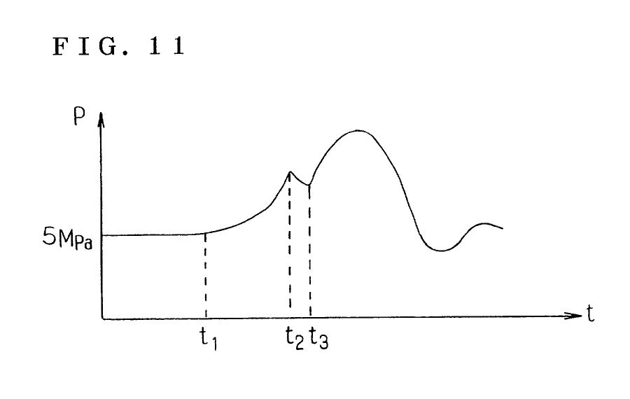

FIG. 12 is a view showing a pressure waveform when an elastic body is disposed on the upstream side of the needle valve; and

FIG. 13 is a view showing another construction of the conventional fuel injection valve.

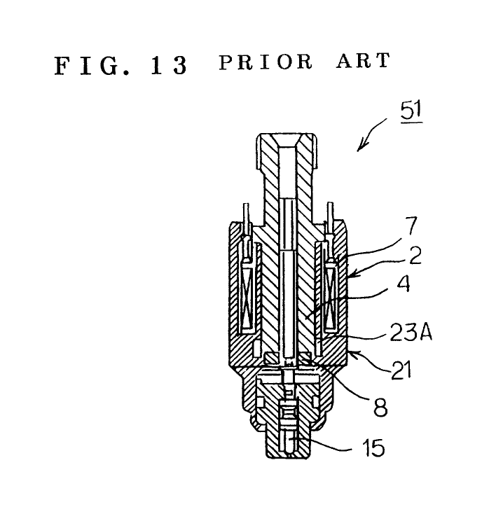

### DESCRIPTION OF THE PREFERRED EMBODIMENTS

An embodiment of the present invention will be described with reference to the accompanying drawings.

1^{st} Embodiment

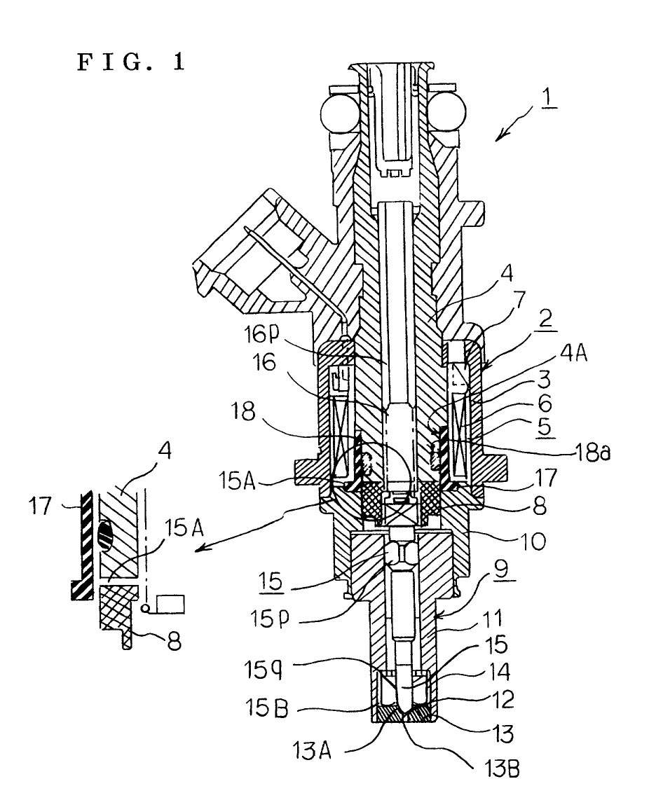

FIG. 1 is a view showing the construction of a fuel injection valve 1 according to the first embodiment of the present invention. In FIG. 1, reference numeral 2 denotes a solenoid, reference numeral 3 denotes a yoke, 4 a core, 5 a coil assembly mounting a coil 6 on a bobbin 7, 8 an armature, and 9 a valve unit connected to a valve holder 10 by means of welding and the like.

This valve unit 9 is provided with a hollow cylindrical valve body 11 having two different outer diameters, a valve seat 13 having an orifice 12 formed at a center end within said valve body 11, a swirler 14 disposed adjacently to the upper portion of said valve seat 13 to give the swirling flow to the injection fuel, and a needle valve 15 having an upper end integrally connected to said armature 8 and a lower end adapted to contact or leave said valve seat 13 by said solenoid 2, thereby opening and closing said orifice 12. Numerals 15p and 15q are an upper sliding portion and a lower sliding portion of said needle valve 15, respectively, while numeral 16 is a spring adapted to energize the needle valve 15 downwardly (in the closing direction). Numeral 16p is a rod serving as a spring pressing member of said spring 16.

In the solenoid 2, a metal sleeve 17 is arranged between the core 4 and the valve holder 10 and connected to the core 4 and the valve holder 10, respectively, by means of welding and the like. With this fastening means, the fastening portion of the sleeve 17 serves to seal the inside fuel. Also, the sleeve 17 and the core 4 axially joins at a step portion 4A formed at a lower portion of the core 4. With this joint, the position of the core 4 is controlled in the axial direction.

Further, the core 4 is provided with a groove 18a on the inner peripheral side of said sleeve 17 and a rubber ring 18 as an elastic member is disposed in the groove 18a to come into contact with said sleeve 17.

An operation of this embodiment will now be described in the following.

In such a condition as the coil 6 of the solenoid 2 is not electrified, the needle valve 15 is energized downwardly by the spring 16 to keep a closing condition. Once said coil 6 is electrified, magnetic flux is generated within a magnetic circuit comprising the armature 8, the core 4 and the yoke 3 and the armature 8 is attracted toward the core 4. Then, the needle valve 15 integrally connected to the armature 8 leaves the valve seat 13 to form an air gap between the needle valve 15 and the valve seat 13. As a result, the fuel of high pressure within the valve body 11 flows into the orifice 12 of the valve seat 13 through said air gap and then is injected through the top port (nozzle opening) 13B into a combustion chamber of an internal combustion engine.

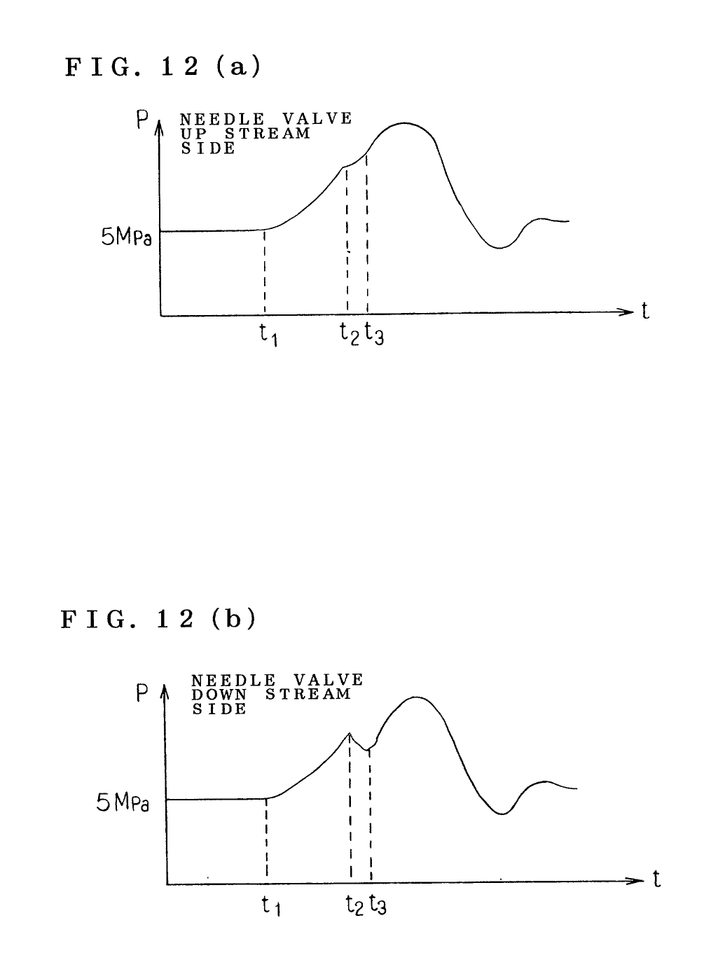

In this first embodiment, the rubber ring 18 is disposed between the sleeve 17 and the core 4. A buffer portion in fuel pressure is formed by making use of the property as an elastic body of the rubber ring 18. The rubber ring 18 is thus used to serve as the so-called accumulator and as a result, it is possible to generate damping relative to the pressure change of fuel in the vicinity of the rubber ring 18. Namely, when a seat portion 13A is slightly opened by the bound of the needle valve 15 right after the valve is closed, pressure drop is produced in the downstream portion 15B of the needle valve 15, while in the upstream portion 15A of the needle valve 15, as described above, since pressure drop of fuel is generated through damping by the accumulator operation of the rubber ring 18, it is possible to generate the pressure difference between the upstream and downstream of needle valve 15 and also possible to effectively apply the load in the valve-closing direction to the needle vale 15 (see FIG. 12). Therefore, since after-dripping of injection due to bouncing of the needle valve 15 right after injection can be controlled, it is possible to prevent the insufficiently granulated fuel from being supplied into the engine and stabilize the combustion quality of the engine.

2^{nd} Embodiment

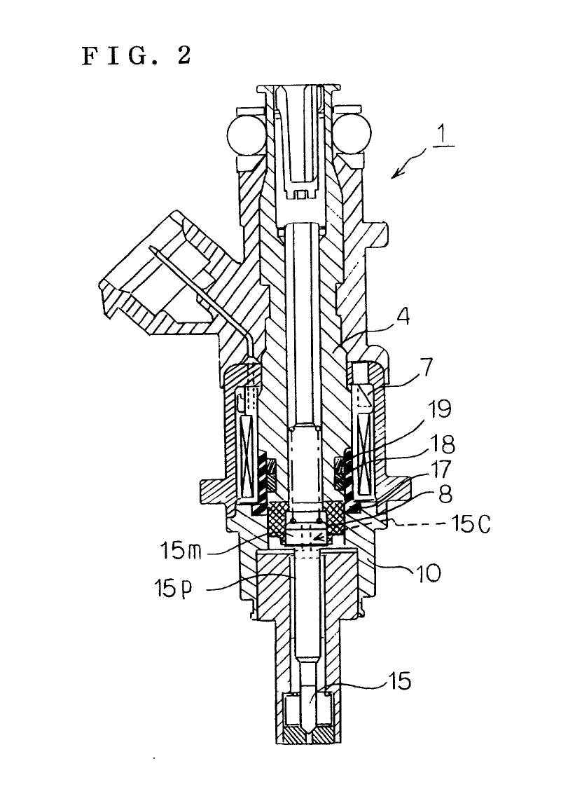

In the first embodiment described above, the rubber ring 18 is arranged between the sleeve 17 and the core 4 to control the bouncing of the needle valve 15 right after injection. However, in the second embodiment, as shown in FIG. 2, a spacer 19 made of an elastic body is inserted behind said rubber ring 18 (opposite side of fuel). Adjustment is made to increase a time constant of delay relative to the fuel pressure and the rubber ring 18 is also arranged in position not to project. With this arrangement, it is possible to further increase the pressure difference between the upstream and downstream sides of the needle valve 15 and certainly control after-dripping of injection due to bouncing of the needle valve 15 right after injection.

Also, in this second embodiment, as shown in FIG. 2, there is provided another type of a fuel injection valve in which said needle valve 15 is designed to have a reduced diameter at its upper sliding portion 15p. A passage of fuel passing the armature 8 is also changed to have a needle valve 15 provided at the inside of the upper portion 15m with a communication opening 15C. Said rubber ring 18 and spacer 19 are also provided in the fuel injection valve. It goes without saying that in the fuel injection valve according to the first embodiment (FIG. 1), the spacer 19 can also be inserted behind the rubber ring 18 to increase the time constant of delay relative to the fuel pressure.

3^{rd} Embodiment

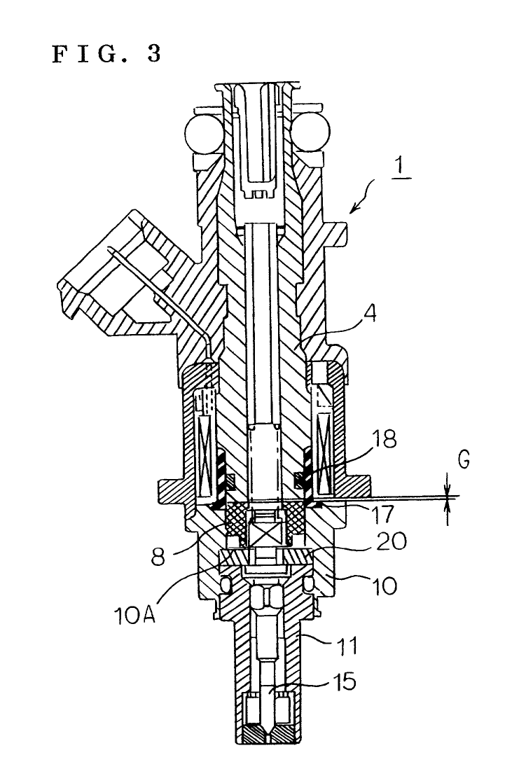

FIG. 3 is a view showing the construction of a fuel injection valve 1 according to the third embodiment of the present invention. In this third embodiment, a stopper 20 is newly added to the components used in FIG. 1, on the upper portion of the valve body 11, for controlling the valve-opening position when the needle valve 15 is opened and for adjusting the air gap. Movement of the stopper 20 is controlled at its upper end by a step portion 10A formed in the valve holder 10. With this arrangement, it is possible to control the delay of transmission of bouncing of the needle valve 15 right after injection, adjust the maximum opening of the needle valve 15 and the size of the air gap G, and stabilize the combustion quality of the engine.

4^{th} Embodiment

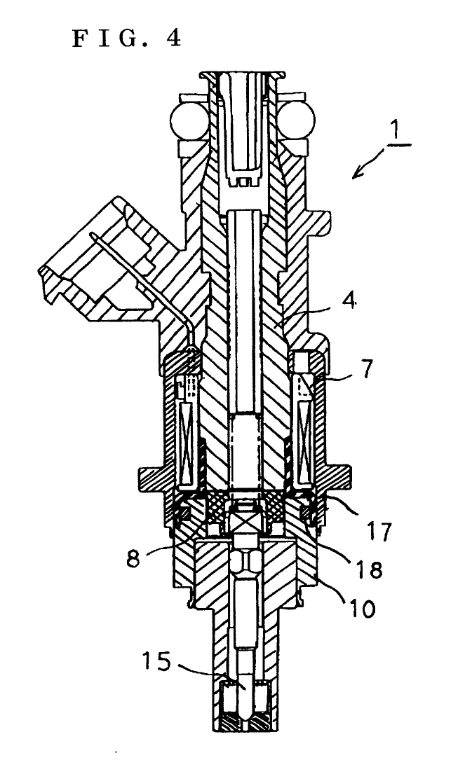

In the first embodiment, the fuel is sealed by the sleeve 17 disposed between the core 4 and the valve holder 10. However, as shown in FIG. 4, there is provided a fuel injection valve 1 of a different type in which the sleeve 17 is extended to the outer periphery of the valve holder 10 and connected to both the outer peripheral portions of the core 4 and the valve holder 10 by means of welding and the like. In this case, the rubber ring 18 is disposed inside said sleeve 17 (fuel side) of the valve holder 10. With this arrangement, it is possible to control after-dripping of injection due to bouncing of the needle valve 15 right after injection in the same manner as the first embodiment.

In the above first to fourth embodiments, the rubber ring 18 is used as an elastic member, but a ring made of plastics and the like may also be used as such an elastic member.

5^{th} Embodiment

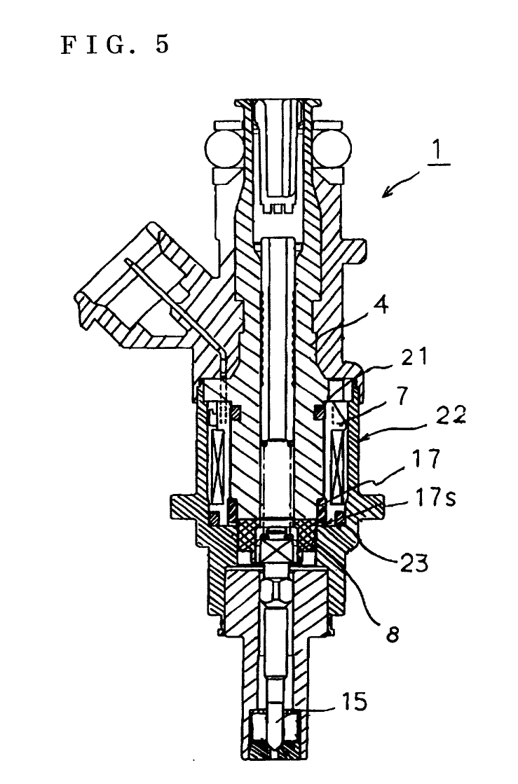

In the first to fourth embodiments described above, there is provided a fuel injection valve in which the sleeve 17 is securely fastened between the core 4 and the valve holder 10 and this fastening portion of the sleeve 17 is designed to seal the fuel. However, in this fifth embodiment, as shown in FIG. 5, a fastening portion of the sleeve 17 does not have such a fuel sealing function as described above. In a fuel injection valve according to the fifth embodiment, a rubber ring 21 disposed between the core 4 and an inner diameter side of a coil bobbin 7, and another rubber ring 23 disposed between the core 4 and a housing 22 are designed to seal the fuel. An air gap 17s is also provided between the sleeve 17 and the housing 22 for propagation of fuel pressure to the gap 17s. By making use of the property as an elastic body of the rubber rings 21 and 23, it is designed to generate a response delay of the fuel pressure relative to the fuel contacting said rubber rings 21 and 23 through said air gap 17s. With this arrangement, it is possible to increase the pressure difference between the upstream and downstream sides of the needle valve 15 and control after-dripping of injection due to bouncing of the needle valve 15 right after injection (spray).

6^{th} Embodiment

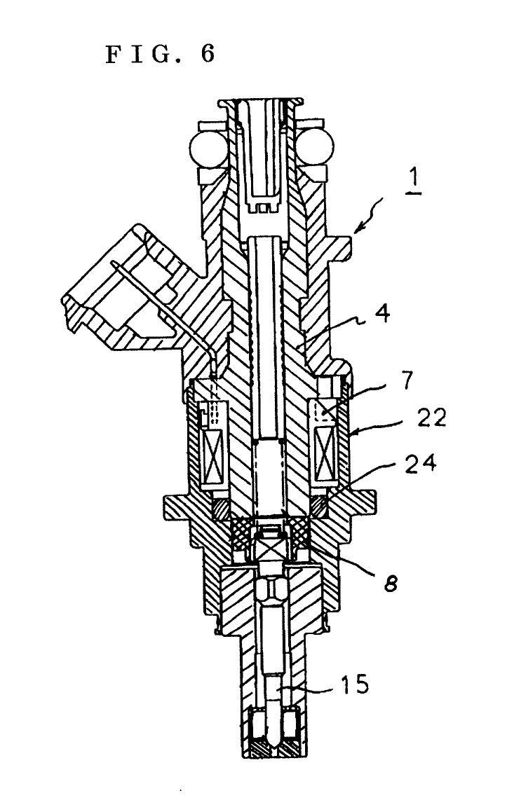

FIG. 6 is a view showing the construction of a fuel injection valve 1 according to the sixth embodiment of the present invention. In this sixth embodiment, a fuel injection valve is provided in which an O-ring 24 is inserted through the coil bobbin 7, on the ignition opening side, between the core 4 and the housing 22 to seal the fuel. By enlarging the diameter of said O-ring 24 (e.g. from 1.9φ to 2.6φ and over), the portion of said O-ring 24 contacting the fuel can also be enlarged, thereby generating the response delay of fuel pressure relative to the fuel contacting the O-ring 24. Thus, it is possible to control after-dripping of injection with a simple construction.

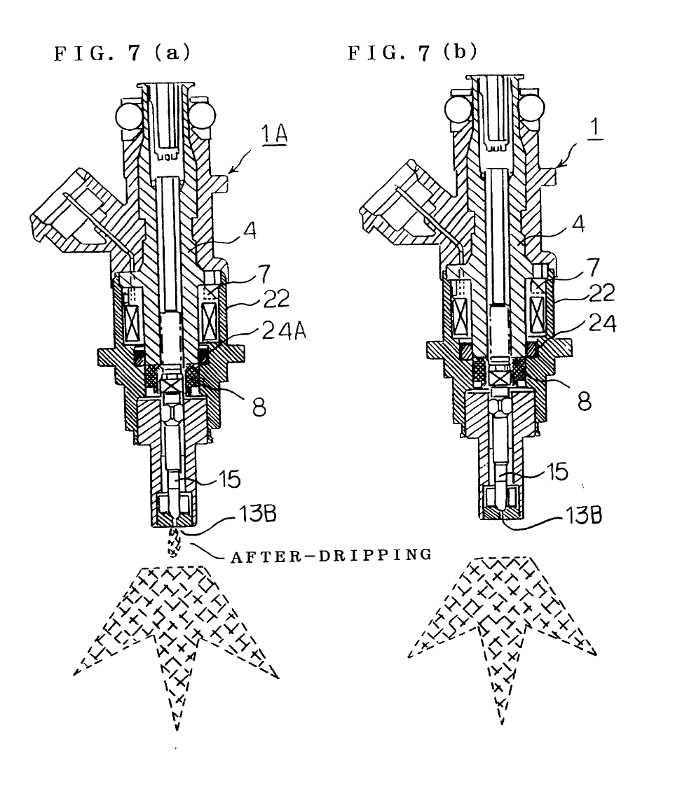

Namely, as shown in FIG. 7(a), in a fuel injection valve 1A using an O-ring 24A whose linear diameter is 1.9φ, since the portion of said O-ring 24A contacting the fuel is small, it is not possible to get such a good result as to fully damp the pressure drop when the needle valve 15 bounds in its closing condition. Accordingly, by the bound when the valve is closed, the needle valve 15 is opened again soon after it is closed and as a result, the fuel is injected from the nozzle opening 13B in a “after-dripping” manner.

On the other hand, as for the fuel injection valve 1 of the present embodiment using the O-ring 24 whose linear diameter is 2.6φ, the portion of the O-ring 24 contacting the fuel is large. It is therefore possible to fully damp the pressure drop when the needle valve 15 bounds in its closing condition. Thus, there is caused the pressure difference between the upstream and downstream sides of the needle valve 15 and it makes the bound of the needle valve 15 smaller. As shown in FIG. 7(b), after-dripping of injection (spray) can not be found.

It is to be noted that the injection (spray) condition as shown in FIGS. 7(a) and (b) has been reproduced based on the photographs taken when the fuel of each fuel injection valve (1A; 1) is injected.

As described above, according to claim 1 of the present invention, there is provided a fuel injection valve, in which a buffer portion for delaying the change of fuel pressure when a needle valve is closed is provided at a portion of an armature contacting the fuel on the upstream side from an end of a nozzle opening, pressure difference is then generated between the upstream and downstream sides of the needle valve under the operation of accumulator by this buffer portion, and the load in the valve-closing direction is effectively applied to the needle valve. With this arrangement, it is possible to control the bouncing after the needle valve is closed and reduce the after-dripping of injection. Accordingly, it is also possible to prevent the fuel that has not been finely granulated from being supplied to an engine and stabilize the combustion quality of the engine.

According to claim 2 of the present invention, there is provided a fuel injection valve in which an elastic member is disposed between a sleeve disposed between a core and a valve holder of a solenoid and said core to delay the change of fuel pressure when the needle valve is closed, and the sleeve is fastened between the core and the valve holder to seal the fuel. With this arrangement, it is possible to reduce the after-dripping of injection by controlling the bouncing after the needle valve is closed and also to stabilize the combustion quality of the engine.

According to claim 3 of the present invention, there is provided a fuel injection valve in which an elastic member is provided between a sleeve disposed between a core and a valve body of a solenoid and extending to the outer periphery of said valve body and said core to delay the change of fuel pressure when the needle valve is closed. Thus, in such a fuel injection valve as to seal the fuel by said sleeve, it is possible to control the bouncing of the needle valve after its closure and reduce after-dripping of injection (spray).

According to claim 4 of the present invention, there is provided a fuel injection valve, in which a coil case is disposed between a core and a valve body and adapted to seal, at the inner and outer diameter sides thereof, said core and valve body by O-rings; a sleeve is provided on the inner diameter side of the coil case and forms an air gap between said sleeve and said valve body; wherein a buffer portion is formed by each of said O-rings. Accordingly, in such a fuel injection valve as to seal the fuel by both said each O-ring and the sleeve, it is possible to delay the change of fuel pressure when the needle valve is closed because the fuel pressure is propagated to each O-ring. It is therefore possible to control the bouncing after the needle valve is closed and reduce after-dripping of injection (spray).

According to claim 5 of the present invention, there is provided a fuel injection valve, in which an O-ring is inserted, on a nozzle opening side of a coil bobbin, between a core and a housing, and said buffer portion is formed by enlarging the diameter of the O-ring so as to enlarge the portion of said O-ring contacting the fuel. With such simple construction, it is possible to generate the effective delay relative to the change of fuel pressure when the needle valve is closed and control the after-dripping of injection (spray).

What is claimed is:

1. A fuel injection valve for opening and closing a needle valve by driving an armature by a solenoid, comprising a buffer portion, for damping the change of fuel pressure when the needle valve is closed, provided at a portion of said armature contacting the fuel, on the upstream side from an end of a nozzle opening side.

2. A fuel injection valve according to claim 1, wherein an elastic member is provided between a sleeve disposed between a core and a valve holder of a solenoid, and said core, to form said buffer portion.

3. A fuel injection valve according to claim 1, wherein an elastic member is provided between a sleeve disposed between a valve holder and a valve holder of the solenoid and extending to the outer periphery of said valve holder, and said core, to form said buffer portion.

4. A fuel injection valve according to claim 1, wherein a coil case is provided between a core and a housing and adapted to seal, at the inner and outer diameter sides thereof, the core and the housing by O-rings, respectively, and a sleeve is provided on the inner diameter side of the coil case and forming an air gap between said sleeve and said valve body, wherein said buffer portion is formed by each of said O-rings.

5. A fuel injection valve according to claim 1, wherein said buffer portion is formed by enlarging the diameter of an O-ring inserted between a core and a housing on a nozzle opening side of a coil bobbin.
